(19) United States
(12) Patent Application Publication
(10) Pub. No.: US 2026/0162568 A1
(43) Pub. Date: Jun. 11, 2026

(54) Support Post Assemblies Having Illuminated Displays

(71) Applicants: Kevin Medeiros, Somerset, MA (US); Heidi Medeiros, Somerset, MA (US)

(72) Inventors: Kevin Medeiros, Somerset, MA (US); Heidi Medeiros, Somerset, MA (US)

(21) Appl. No.: 19/180,569

(22) Filed: Apr. 16, 2025

Related U.S. Application Data
(60) Provisional application No. 63/634,626, filed on Apr. 16, 2024.

(51) Int. Cl. G09F 13/06; F21S 8/08; F21S 9/03; F21W 111/02; G09F 13/04

(52) U.S. Cl. CPC G09F 13/06; F21S 8/088; F21S 9/035; G09F 13/0495; F21W 2111/02

(57) ABSTRACT

Support post assemblies such as, for example, mailbox, lantern, fence, lamp, patio, and deck posts, having illuminated displays are provided. The support post assembly preferably comprises: i) an elongated, upright support post having an interior chamber, ii) an interior frame mounted in the interior chamber, and iii) a lighting sub-assembly The support post assembly can be illuminated with the lighting sub-assembly so that letters, numbers, symbols, and other decorative indicia marked on the support post, are visible during nighttime hours. Methods for manufacturing support post assemblies having illuminated displays are also provided.

### CROSS-REFERENCE TO RELATED APPLICATIONS

The application claims the benefit of U.S. Provisional Patent Application No. 63/634,626 filed Apr. 16, 2024, the entire disclosure of which is hereby incorporated by reference.

### BACKGROUND OF THE INVENTION

### Field of the Invention

The present invention relates generally to support post assemblies having illuminated displays. More particularly, the present invention relates to support post assemblies such as, for example, mailbox, lantern, fence, and deck posts that can be illuminated with a light source so that letters, numbers, symbols, and other decorative indicia, that are marked on the support post, are visible during nighttime hours. The present invention also encompasses methods for manufacturing support post assemblies having illuminated displays.

### Brief Review of the Related Art

Support posts are used in a wide variety of assemblies including, but not limited to, mailbox, lantern, lamp, fence, patio, and deck building structures. The support posts are generally made from wood, metal, or plastic materials. Lamp fixtures can be mounted on top of the support posts to provide different lighting effects. In recent years, longitudinal support posts having a hollow interior chamber have been used in these assemblies. For example, with mailbox assemblies, a hollow support post is placed into the ground so that it stands upright. The support post is anchored in the ground. A transverse beam extends outwardly from the support post. Normally, the transverse beam is attached to the upper region of the support post. There also can be a diagonally-placed beam that extends upwardly from the middle region of the support post to the transverse beam. This diagonal beam helps to reinforce the mailbox assembly. However, conventional mailbox assemblies have some drawbacks.

For example, one problem is that numbers, letters, and other indicia markings printed on the mailbox are often non-visible during dusk and evening hours. This makes it difficult for a delivery person, guest, or other person to identify the correct home or commercial building. There is a need for a mailbox assembly having a lighting system that can be turned on during nighttime hours. In this manner, the operator of a vehicle or other person will be able to clearly locate and identify the numbers, letters, and other decorative indicia on the mailbox assembly at any time. The present invention provides mailbox and other assemblies having such a lighting system. These assemblies include, but are not limited to, mailbox, lantern, lamp, fence, patio, and deck building structures. Other advantages, features, and benefits of the present invention are described further below.

### SUMMARY OF THE INVENTION

The present invention provides support post assemblies having illuminated displays. More particularly, the present invention relates to support post assemblies such as, for example, mailbox, lantern, lamp, fence, patio, and deck posts that can be illuminated with a light source so that the letters, numbers, and other decorative indicia are clearly visible when there is no daylight.

In one preferred embodiment, the support post assembly comprises: i) an elongated, upright support post having an interior chamber, the elongated support post having an interior surface and outer surface, wherein a portion of the support post contains cut-out indicia so that the interior chamber is visible through the cut-out indicia; ii) an interior frame mounted in the interior chamber, the interior frame comprising a first side panel and an opposing second side panel; and a bottom end panel, wherein the end panel is joined to the side panels; and a transverse panel, wherein the transverse panel extends from first side panel to the second side panel; and iii) a lighting sub-assembly comprising a lighting fixture, the lighting sub-assembly, being mounted on the interior frame, wherein the lighting sub-assembly transmits light rays through the indicia, so the indicia is visible during nighttime hours. The interior frame preferably includes a translucent panel that provides a background so the cut-out indicia on the post is visible during daytime hours and nighttime hours.

The support post assembly can be used in a variety of building structures such as those selected from the group consisting of mailboxes, lanterns, lamps, fences, patios, and decks. In one preferred embodiment, the support post comprises an upper portion having a top end cap, and a solar panel is mounted to the top end cap. The lighting sub-assembly may further comprise a photovoltaic cell for converting sunlight energy captured by the solar panel to electricity. In another embodiment, the lighting sub-assembly further comprises a lamp socket for installing a lightbulb. Suitable lighting fixtures include, for example, those selected from the group consisting of bulbs, lamps, tubes, or light-emitting-diodes, and combinations thereof.

The present invention also encompasses methods for manufacturing support post assemblies. In one embodiment, the method comprises the steps of: i) providing an elongated support post having an interior chamber, the elongated support post having an interior surface and outer surface; ii) placing a template containing indicia on the outer surface of the support post and tracing the indicia onto the outer surface of the support post; iii) cutting-out the traced indicia so that an outline of the indicia is provided on the outside surface of the support post and the interior chamber of the support post is visible; iv) mounting an interior frame in the interior chamber of the support post, the interior frame comprising a first side panel and an opposing second side panel; and a bottom end panel, wherein the end panel is joined to the side panels; and a transverse panel, wherein the transverse panel extends from first side panel to the second side panel; v) placing a translucent panel against a portion of the interior surface of the support post so that the cut-out indicia on the support post is visible during daytime hours; and vi) mounting a lighting sub-assembly comprising a lighting fixture to the interior frame, wherein the lighting sub-assembly transmits light rays through the indicia, so the indicia is visible during nighttime hours.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1. is a perspective view of one embodiment of the support post assembly of the present invention showing a lantern positioned on a top end cap;

FIG. 2 is a top-down view of one embodiment of a section of the support post assembly of the present invention showing an inner frame positioned within a support post;

FIG. 3 is a perspective view of one embodiment of the support post assembly of the present invention showing a support post, inner frame, and lighting sub-assembly in detail;

FIG. 4 is another perspective view of one embodiment of the support post assembly of the present invention showing a support post, inner frame, and lighting sub-assembly in detail;

FIG. 5 is a perspective view of another embodiment of the support post assembly of the present invention showing a solar panel positioned on a top end cap; and

FIG. 6 is a perspective view of another embodiment of the support post assembly of the present invention showing a mailbox positioned on a transversely extending beam.

### DETAILED DESCRIPTION OF THE INVENTION

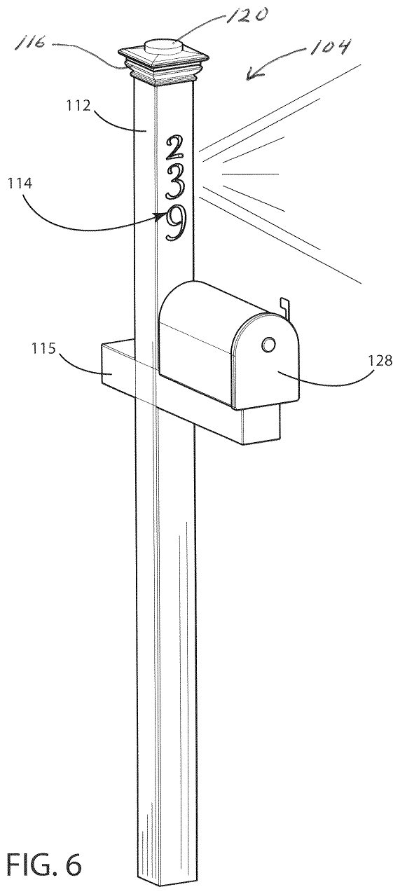

The present invention relates generally to support post assemblies (110) having illuminated displays. More particularly, the present invention relates to support post assemblies (110) such as, for example, mailbox, lantern, and fence posts that can be illuminated with a light source so that the letters, numbers, and other decorative indicia are clearly visible when there is no daylight. The following description primarily refers to a mailbox support post assembly, but it should be understood that any suitable support post assembly including, but not limited to, mailbox, lantern, lamp, fence, patio, and deck support post assemblies, can be manufactured in accordance with the present invention. The support post assemblies are generally made from wood, metal, or plastic materials and can be used in a variety of building structures Referring to the Figures, one embodiment of a mailbox support post assembly (104) of the present invention is shown in FIG. 6.

As illustrated in FIG. 6, the mailbox assembly (104) comprises: a) an elongated, vertically-extending post (112); and b) an elongated horizontally-extending beam (115) that supports the mailbox (128). The mailbox post assembly (104) can be made of any suitable material including, for example, metals, wood, and plastics. However, as discussed further below, it is important that the elongated post (112), that stands upright, has an interior chamber. In one preferred embodiment, the elongated post (112) is made of a plastic vinyl material such as polyvinyl chloride (PVC).

The elongated, upright post (112) is typically made of a four-inch by four-inch square (4″×4″) or five-inch by five-inch square (5″×5″) beam. However, the post (112) can have any suitable shape including, but not limited to, square, rectangular, circular, oval, triangular, square, diamond, pentagonal, hexagonal, heptagonal, and octagonal, and the like. The elongated, upright post (112) has a first (upper) end and an opposing second (lower) end that is anchored in the ground using cement, dirt, or other suitable material. A top end cap (116) can be placed over the first (upper) end of the upright post (112) to provide an aesthetic finish and prevent weather elements and other materials from entering the interior chamber of the post.

As further shown in FIG. 6, the mailbox assembly (104) further includes a transverse beam (115) extending horizontally from the elongated, upright post (112). The transverse beam (115) can be fastened to the upright post (112) using any suitable fastening means such as, for example, screw, bolts, rivets, and the like. The transverse beam (115) has a first end and an opposing second end. The transverse beam (115) can also have an interior chamber. A first end cap can be placed over the first end of the transverse beam (115), and a second end cap can be placed over the second end of the transverse beam (115) These caps can provide an aesthetic finish and prevent weather elements and other materials from entering the interior chamber of the transverse beam (115). A traditional mailbox (128) can be mounted on the upper surface of the transverse beam (115) More particularly, an illuminated mailbox assembly (104) can be made in accordance with the following steps of the present invention. The illuminated display is described further below.

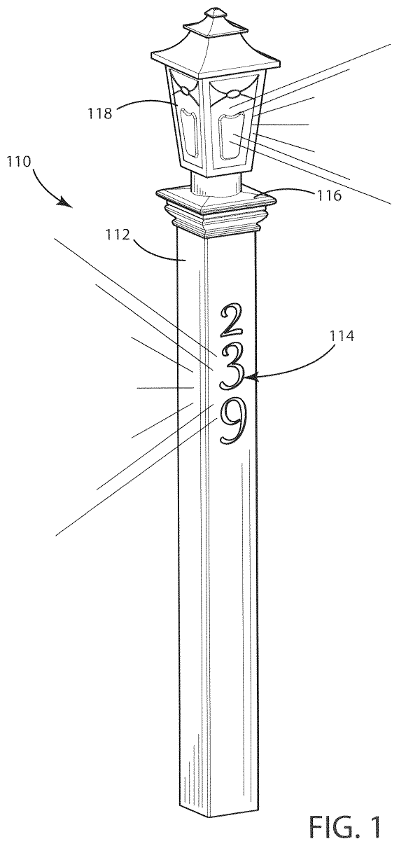

In another example, a lantern support post assembly (110), as shown in FIG. 1, is provided. The lantern support post assembly (110) comprises an elongated, upright support post (112) having a top end cap (116). A lantern lighting fixture (118) is fastened to the top end cap (116).

The methods for manufacturing the support post assemblies of the present invention comprise several steps. In one preferred embodiment of a method, the first step involves placing a template containing the desired indicia (114) (for example, letters, numbers, shapes, pictures, and any other decorative symbols) against the outside surface of the elongated support post (112) and then tracing the decorative indicia (114) onto the surface of the support post. Any suitable writing instrument can be used for tracing the decorative indicia (114).

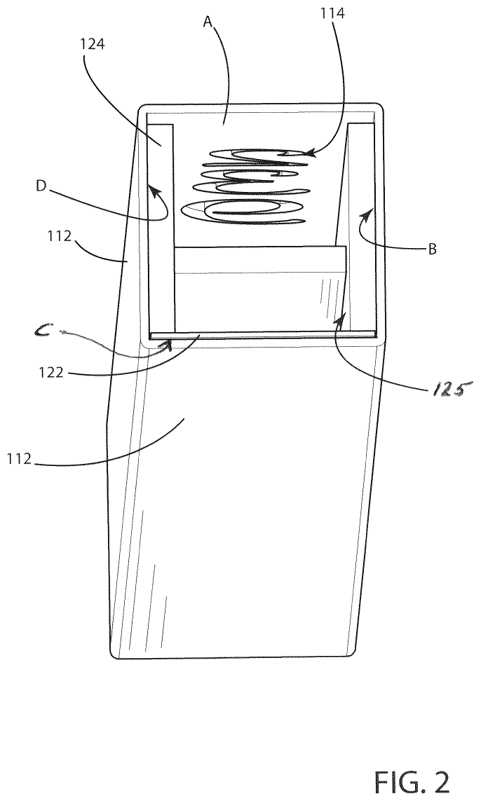

As shown in FIG. 2, in a second step, the traced indicia (114) is cut-out of the surface of the support post (112) so that an outline of the indicia markings (114) is provided on the surface of the support post (112); and the interior chamber (125) of the support post (112) is visible by looking through the outlined indicia sections (114). A handheld router tool can be used to cut-out the indicia (114) and form the outline of the indicia markings. In this way, the interior chamber (125) of the support post (112) is plainly visible to a person looking through the cut-out indicia (114) of the support post.

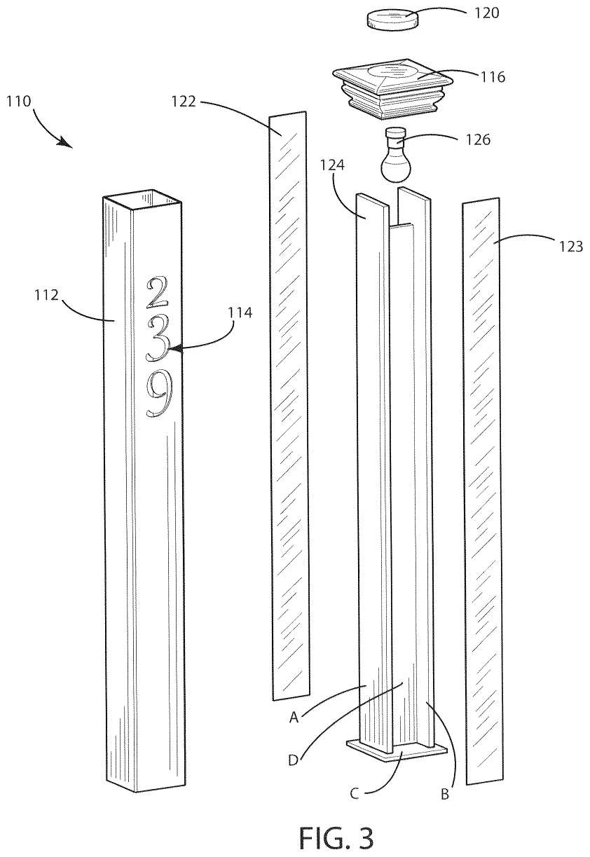

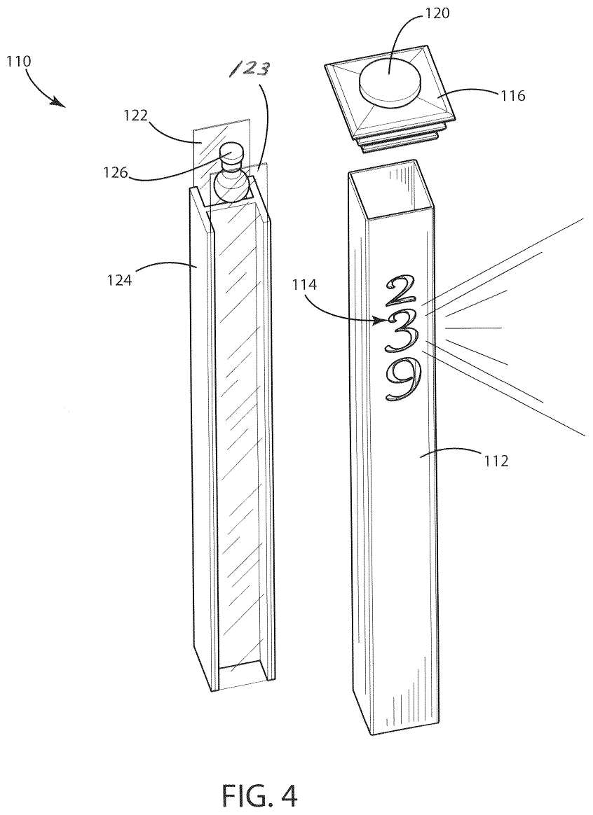

Referring to FIGS. 3 and 4, in a third step, an interior frame (124) for the support post (112) is constructed. The interior frame (124) comprises a first side panel (A) and an opposing second side panel (B); and a bottom end panel (C), wherein the bottom end panel (C) is joined to the side panels (A) and (B). A transverse panel (D), wherein the transverse panel (D) extends from first side panel (A) to second side panel (B), is also part of the interior frame (124). The transverse panel (D) is perpendicular to the first and second side panels (A and B). The bottom end panel (C) provides a base for the interior frame (124) and is joined to the first and second side panels (A, B) and the transverse panel (D). The interior frame (124) is preferably a unitary, integrated structure.

Turning back to FIG. 2, the interior chamber (125) of the support post (112) has an interior surface comprising four interior surface segments (A1, B1, C1, and D1). Interior surface segment (A1) contains the cut-out indicia markings (114). In a fourth step, the interior surface segment (C1), which is opposite of the interior surface segment (A1), is covered with an opaque material, which is preferably an opaque panel (122). The opaque panel (122) is positioned so that it makes contact with the interior frame (124) and the interior surface (particularly segment (C1)) of the support post (112). That is, the opaque panel (122) is an intermediate layer disposed between the interior frame (124) and the interior surface of the support post (112). More particularly, as shown in FIGS. 2 and 3, one edge of opaque panel (122) rests against side panel (A) of the interior frame (124); and the opposing edge of the opaque panel (122) rests against side panel (B) of the interior frame (124). When the interior frame (124) is placed within the interior chamber (125) of the support post (112), the opaque panel (122) also rests against the interior surface of the support post (112). As described above, the interior surface segment (C1) does not contain the cut-out indicia (114). This opaque panel (122) prevents light rays from shining through the support post (112) and into the interior chamber (125).

In one preferred embodiment, a hard vinyl plastic opaque panel (122) is cut to fit the interior surface segment (C1) of the support post (112). The opaque covering panel (122) may be fastened to the interior frame (124) and interior surface segment (C1) using any suitable fastening means, or the opaque covering panel (122) may rest freely between these points. In one preferred embodiment, Azek® polyvinyl chloride sheet having a thickness of about one-quarter inch (¼″) is used as the opaque covering panel (114).

As shown in FIGS. 3 and 4, in a fifth step, a translucent panel (123) is cut to fit the interior surface segment (A1) of the support post (112). The translucent panel (123) is positioned so that it makes contact with the interior frame (124) and the interior surface (particularly segment (A1)) of the support post (112). That is, the translucent panel (123) is an intermediate layer disposed between the interior frame (124) and the interior surface of the support post (112). More particularly, as shown in FIGS. 2 and 3, one edge of translucent panel (123) rests against side panel (A) of the interior frame (124); and the opposing edge of the translucent panel (123) rests against side panel (B) of the interior frame (124). When the interior frame (124) is placed within the interior chamber (125) of the support post (112), the translucent panel (123) also rests against the interior surface of the support post (112). As described above, interior surface segment (A1) contains the cut-out indicia (114). The translucent panel (123) provides a suitable background so that the cut-out indicia (114) on the support post (112) is clearly visible during daytime hours. The translucent panel (123) can be tinted. At nighttime, the translucent panel (123) allows the light rays generated from the interior chamber (125) of the support post (112) to shine through the post as shown in FIG. 4.

In one preferred embodiment, a Plexiglass tinted panel (123) is used, and the panel has a thickness of about one-eighth inch (⅛″). The translucent panel (123) may be fastened to the interior frame (124) and interior surface segment (A1) using any suitable fastening means, or the transparent panel (123) may rest freely between these points. The translucent panel (123) provides a suitable background so that the cut-out indicia (114) on the support post (112) is clearly visible during daytime hours. The transmitting of light from the lighting sub-assembly in the interior chamber (125) of the support post (112) makes the cut-out indicia (114) on the surface of the post (112) clearly visible during nighttime hours. Furthermore, the tinted Plexiglass sheet or other tinted substrate panel (123) allows the cut-out indicia (114) on the support post (112) to be clearly seen during daytime hours when natural light is striking the post.

As further shown in FIGS. 3 and 4, if a solar-powered light is used as the light source, a top end cap (116) having an opening (for example, cut-out hole) for receiving a solar panel (120) can be mounted on the top of the support post (112). Then, the solar panel (120) can be mounted in the opening of the cap (116). The electronic circuits are protected by the top end cap (116). In general, the solar panel (120) captures sunlight energy during the day and photovoltaic cells convert this energy to electricity. The electrical current is fed to a controller that charges the battery. A photocell senses when there is darkness and sends a signal to the light controller which directs the battery to power on the lighting source (126) (for example, bulbs, lamps, tubes, or light-emitting-diodes (LEDS)). As nighttime passes, the photocell determines when there is sufficient daylight. In turn, the photocell sends a signal to the controller which directs the battery to power-off the lighting system. During the daytime, the solar panels (120) will go back to capturing the sunlight energy and the controller will charge the battery.

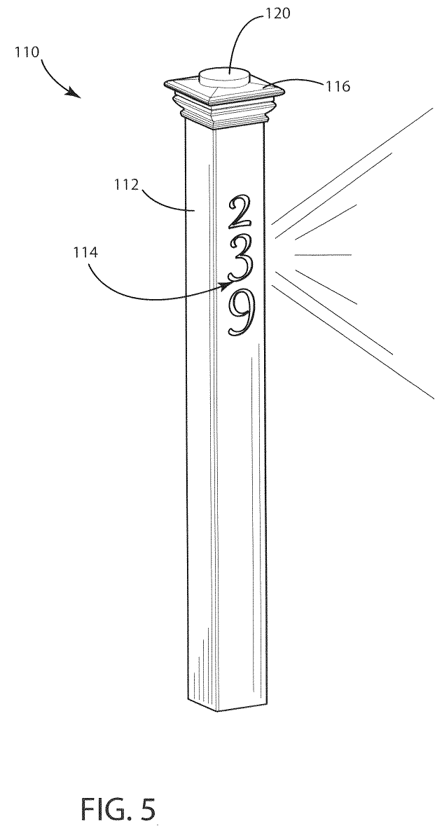

Referring to FIG. 5, the light controller system of the support post (112) can generate power during darkness so the cut-out numbers, letters, pictures, symbols, and any other decorative indicia (114) on the outer surface of the post (112) are brightly illuminated. This makes the numbers, letters, pictures, symbols, and any other decorative indicia (114) marked on the surface of the support post (1120 clearly visible during nighttime hours.

For an electrically hard-wired system, a keyless lamp socket can be installed at the upper end of the support post (114), and the lighting source (126) can be hardwired by running low-voltage wires from the home or other building to the socket. Any suitable lighting source (126) including, but not limited to, bulbs, lamps, tubes, or light-emitting-diodes (LEDS) can be used.

The support post assemblies of the present invention provide aesthetically-pleasing lighting effects with bright and clear illuminated displays. As discussed above, solar-powered and electrically hard-wired systems can be used in accordance with the present invention. The support post assemblies can be used in mailbox posts, lantern posts, lamps posts, decks, patios, fences and other structures. In the present invention, the letters, numbers, pictures, symbols, and other decorative indicia on the posts are clearly visible during both daylight and nighttime hours.

It should be understood that the terms, “first”, “second”, “top”, “bottom”, “upper”, “lower”, “upwardly”, “downwardly”, “above” “below”, “right”, “left”, “interior”, “exterior,” “outer”, “A,” “A1,” “B,” “B1,” “C” “C1,” “D,” “D1,” and the like are arbitrary terms used to refer to one position of an element based on one perspective and should not be construed as limiting the scope of the invention.

It also should be understood that the assemblies, sub-assemblies, materials, constructions, and the like described and illustrated herein represent only some embodiments of the invention. It is appreciated by those skilled in the art that various changes and additions can be made to the assemblies, sub-assemblies, materials, and constructions and the like without departing from the spirit and scope of this invention. It is intended that all such embodiments be covered by the appended claims.

We claim:

1. A support post assembly, comprising;
an elongated, upright support post having an interior chamber, the elongated support post having an interior surface and outer surface, wherein a portion of the support post contains cut-out indicia so that the interior chamber is visible through the cut-out indicia;
an interior frame mounted in the interior chamber, the interior frame comprising a first side panel and an opposing second side panel; and a bottom end panel, wherein the end panel is joined to the side panels; and a transverse panel, wherein the transverse panel extends from first side panel to the second side panel;
a lighting sub-assembly comprising a lighting fixture, the lighting sub-assembly, being mounted on the interior frame, wherein the lighting sub-assembly transmits light rays through the indicia, so the indicia is visible during nighttime hours.

2. The support post assembly of claim 1, wherein the interior frame further comprises a translucent panel that provides a background so the cut-out indicia on the post are visible during daytime hours and nighttime hours.

3. The support post assembly of claim 1, wherein the support post assembly is used in a building structure selected from the group consisting of mailboxes, lanterns, fences, lamps, patios, and decks.

4. The support post assembly of claim 1, wherein the support post further comprises a top end cap, and a solar panel is mounted to the top end cap.

5. The support post assembly of claim 4, wherein the lighting sub-assembly further comprises a photovoltaic cell for converting sunlight energy captured by the solar panel to electricity.

6. The support post assembly of claim 1, wherein the lighting sub-assembly further comprises a lamp socket for installing a lightbulb.

7. The support assembly of claim 1, wherein the lighting fixture is selected from the group consisting of bulbs, lamps, tubes, or light-emitting-diodes, and combinations thereof.

8. A method for manufacturing a support post assembly, comprising the steps of:
providing an elongated support post having an interior chamber, the elongated support post having an interior surface and outer surface;
placing a template containing indicia on the outer surface of the support post and tracing the indicia onto the outer surface of the support post;
cutting-out the traced indicia so that an outline of the indicia is provided on the outside surface of the support post and the interior chamber of the support post is visible;
mounting an interior frame in the interior chamber of the support post, the interior frame comprising a first side panel and an opposing second side panel; and a bottom end panel, wherein the end panel is joined to the side panels; and a transverse panel, wherein the transverse panel extends from first side panel to the second side panel;
placing a translucent panel against a portion of the interior surface of the support post so that the cut-out indicia on the support post is visible during daytime hours; and
mounting a lighting sub-assembly comprising a lighting fixture to the interior frame, wherein the lighting sub-assembly transmits light rays through the indicia, so the indicia is visible during nighttime hours.

9. The method of claim 8, wherein the support post assembly is used in a building structure selected from the group consisting of mailboxes, lanterns, fences, lamps, patios, and decks.

10. The method of claim 8, wherein the support post comprises an upper portion having a top end cap, and a solar panel is mounted to the top end cap.

11. The method of claim 8, wherein the lighting sub-assembly further comprises a lamp socket for installing a lightbulb.

12. The method claim 8, wherein the lighting fixture is selected from the group consisting of bulbs, lamps, tubes, or light-emitting-diodes, and combinations thereof.
